(19) United States
(12) Patent Application Publication
(10) Pub. No.: US 2021/0048148 A1
(43) Pub. Date: Feb. 18, 2021

(54) PROCESS AND APPARATUS FOR DISPENSING AND CHARGING GAS TO A STORAGE VESSEL

(71) Applicant: NuMat Technologies Inc., Skokie, IL (US)

(72) Inventors: Glenn McPherson Tom, Bethany Beach, DE (US); Jose Arno, Chicago, IL (US)

(73) Assignee: NuMat Technologies Inc., Skokie, IL (US)

(21) Appl. No.: 16/990,170

(22) Filed: Aug. 11, 2020

Related U.S. Application Data
(60) Provisional application No. 62/885,717, filed on Aug. 12, 2019.

(51) Int. Cl. F17C 13/04; B05B 12/08; F17C 7/00

(52) U.S. Cl. CPC F17C 13/04; B05B 12/088; F17C 7/00; F17C 2201/0119; F17C 2205/0332; F17C 2270/0518; F17C 2205/0338

(57) ABSTRACT

A valve assembly and process are disclosed that permit charging and dispensing gas from a storage vessel through one passage and one nozzle. Only one passage is in communication with the pressurized gas in the storage vessel which focuses safety measures on a single passage. Gas is passed through a single regulator to dispense gas from the storage vessel and to charge the storage vessel. The regulator utilizes a diaphragm which when pressurized by a separate fluid permits passage through the regulator. This separate fluid does not have access to the interior of the storage vessel.

### CROSS-REFERENCE TO RELATED APPLICATIONS

This application claims priority from provisional application 62/885,717, filed Aug. 12, 2019, incorporated herein in its entirety.

### FIELD

The field relates to a valve assembly for a gas storage vessel useful in applications such as manufacturing semiconductor materials and devices.

### BACKGROUND

In a wide variety of industrial processes and applications, there is a need for a reliable source of process gas(es). Such process and application areas include semiconductor manufacturing, ion implantation, manufacture of flat panel displays, medical intervention and therapy, water treatment, emergency breathing equipment, welding operations, space-based delivery of liquids and gases, etc.

It is important in the industry to provide a safe and effective way to handle toxic, flammable, corrosive gases at sub-atmospheric conditions. In particular, these gases include dopant gases. Generally, dopant gases are stored in compressed gas cylinders at pressures equal to the gas vapor pressure at a given or at a specific pressure depending upon the properties of the specific gas. The gases serve as a source of dopant material for the manufacturing of semiconductor devices. These dopant gases are used in a tool called an ion implanter. Ion implanters are located within the fabrication area of a semiconductor production facility where several hundreds or even thousands of personnel are engaged in the semiconductor manufacturing process. These tools are operated at very high voltages, typically up to several thousand kilovolts. Due to these high voltages, the dopant source gases must be located at or within the tool itself. Most other semiconductor tools locate source gases outside of the personnel or main production area. One distinct characteristic of the ion implant tools is that they operate at sub-atmospheric pressure. Utilization of the vacuum present at the tool to deliver product from the cylinder creates a safer package in that product cannot be removed from the cylinder package until a vacuum is applied. This vacuum delivery concept prevents accidental exposure to the pressurized gas.

One technique for safely delivering sub-atmospheric delivery of dopant gases involves filling a compressed gas cylinder with a physical adsorbent material, such as beaded activated carbon, and reversibly adsorbing the dopant gases onto the material. This concept is commonly known as the SDS technology. The desorption process involves applying a vacuum or heat to the adsorbent material/cylinder.

A mechanical check valve may be used for safe sub-atmospheric delivery of dopant gases. The check valve is configured to open when sub-atmospheric or vacuum conditions are applied to the device. The check valve is located upstream of a conventional on/off cylinder valve seat mechanism. The exact location of this upstream device can be in the valve body, in the cylinder neck cavity, inside the cylinder itself, or combinations of all three locations.

A regulator(s) may also be used for safe sub-atmospheric delivery of dopant gases. The regulator(s) is pre-set to deliver product at a specific sub-atmospheric pressure. The regulator(s) may be located upstream of the cylinder on/off valve seat such as in the cylinder neck cavity or inside the cylinder itself or downstream of the cylinder on/off valve seat.

These techniques and devices all require a separate passage for recharging the cylinder with the gas.

It would be desirable to provide even safer devices for dispensing and charging gas to a storage device.

### SUMMARY

Disclosed is a valve assembly for dispensing gas from a storage vessel that comprises a single nozzle for communicating gas with the storage vessel. The valve assembly has a passage having two ends. A first end is in communication with the single nozzle, and a second end is in communication with an interior of the storage vessel where the gas is stored. A regulator is interposed in the passage for regulating the flow of gas through the passage. The regulator has three ports: a storage vessel port, a single nozzle port and a pressure regulator port. The valve assembly permits charging and dispensing gas through the single nozzle. The process for dispensing gas from the storage vessel involves opening a shut off valve to communicate the passage with the nozzle. Pressure is applied to a first side of a diaphragm which flexes to open a gas valve in the passage. Gas is permitted to pass from the storage vessel through the passage past the gas valve and past the shut off valve to the nozzle.

### BRIEF DESCRIPTION OF THE DRAWINGS

FIG. 1 is a schematic cross-sectional elevation view of a gas storage and dispensing system according to one embodiment of the present invention.

FIG. 2 is an isometric view of an alternative valve assembly of FIG. 1.

### DETAILED DESCRIPTION

A valve assembly and process are disclosed that permit charging and dispensing gas from a storage vessel through one passage and one nozzle. Only one passage is in communication with the pressurized, toxic gas in the storage vessel which focuses safety measures on a single passage. The term “communication” means that material flow is operatively permitted between enumerated components. Gas is passed through a single regulator to dispense gas from the storage vessel and to charge the storage vessel. The regulator utilizes a diaphragm which when pressurized by a separate fluid permits passage through the regulator. This separate fluid does not have access to the interior of the storage vessel.

The valve assembly provides a reliable source of gas having particular suitability for use in semiconductor manufacturing facilities to provide on-demand supply of gases, such as halocompound gases; e.g., BF₃, F₂, etc., hydride gases; e.g., arsine, phosphine, etc., and gaseous organometallic source reagents.

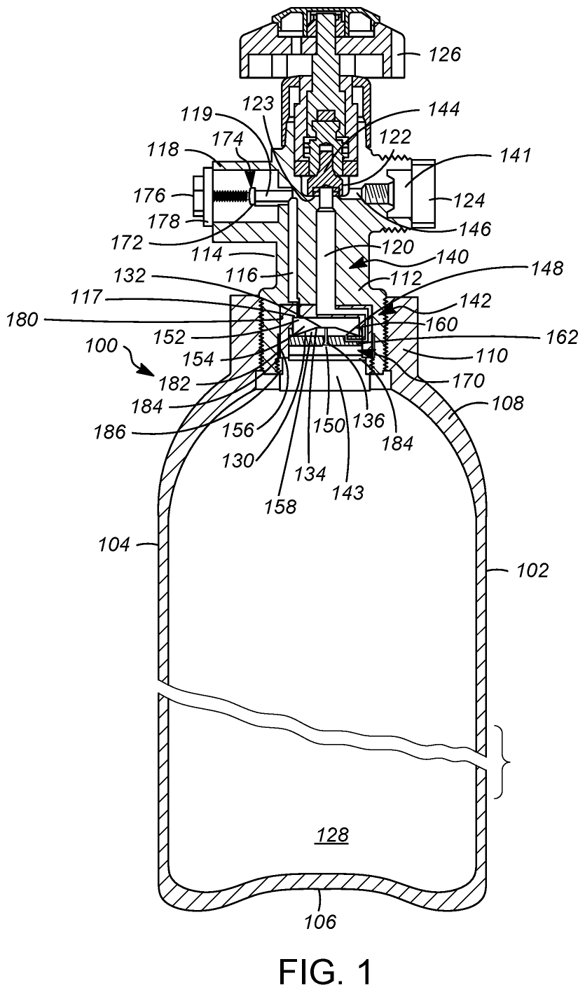

Referring now to the drawings, FIG. 1 is a schematic cross-sectional elevation view of one gas storage vessel 100 according to an illustrative embodiment. The storage vessel 100 may be a fluid storage and dispensing vessel of generally cylindrical form, with a cylindrical sidewall 104 closed at its lower end by floor member 106. At the upper end of the vessel is a neck 108 including a cylindrical collar 110 defining and circumscribing a top opening of the vessel 100. The sidewall 104, floor member 106 and neck 108 thereby enclose an interior volume 128 of the vessel 100, as shown.

At the neck of the vessel, a threaded plug 112 of a valve assembly 114 is threadably coupled with the interior threaded opening of the collar 110 of the storage vessel 100. The valve assembly 114 includes a passage 140 having a first end 141 in communication with a single nozzle 124 and a second end 143 of the passage 140 is in communication with the interior volume 128 of the vessel 100. The single nozzle 124 is the only nozzle that communicates the interior volume 128 of the vessel 100 with outside of the vessel. Hence, the single nozzle is for dispensing gas from the vessel 100 and charging gas to the vessel. The passage 140 has several segments. A central segment 120 of the passage 140 passes between a shut off valve 122 and a regulator 142.

The shut off valve 122 is interposed in the passage 140 for blocking or allowing gas to pass between the first end 141 and the second end 143 of the passage 140. The shut off valve 122 is sealed having an orifice in a seat 123 on a side of the valve toward the central segment 120. A flexible member 144 is displaced by gas when the flexible member is in a relaxed condition to allow gas to flow past the shut off valve 122 enabling communication between the central segment 120 and a nozzle segment 146 of the passage 140. When a hand wheel 126 is cranked clockwise it compresses the flexible member 144 which enters a compressed condition that prevents passage of gas through the orifice past the shut off valve 122. The nozzle segment 146 is part of the passage 140 that communicates with the central segment 120 through the shut off valve 122 with the single nozzle 124.

The other end of the central segment 120 opposite to the shut off valve 122 communicates with a regulator 142 through a nozzle port 148. In an aspect, the central segment 120 wends around the regulator 142 and through a base 162 of the regulator at the nozzle port 148. The nozzle port 148 is one of three ports to the regulator 142. The other two ports are a vessel port 150 and a pressure port 152. The regulator 142 is interposed in the passage 140 for regulating the flow of gas through the passage between the storage vessel 100 and the shut off valve 122. The regulator may be located in the passage 140 between the shut off valve 122 and the storage vessel 100.

The regulator 142 comprises a chamber 154 disposed in a cavity 156 in the valve assembly 114. The cavity 156 may be located in the threaded plug 112. The chamber 154 is divided by a diaphragm 130 into a passage plenum 158 and an annex 160. The diaphragm 130 may be configured as a dome with its apex projecting into the annex 160. The passage plenum 158 is located between the diaphragm 130 and a base 162 of the chamber 154 of the regulator 142. The annex 160 is disposed in the chamber 154 outside of the passage plenum 158. The central segment 120 of the passage 140 passes through the passage plenum 158. In an aspect, the central segment 120 of the passage 140 is burrowed through the base 162.

The diaphragm 130 has a first side 132 and a second side 134. The first side 132 of the diaphragm may be viewed as an exterior side 132, and the second side 134 may be viewed as an interior side 134 with respect to the base 162. The first side 132 of the diaphragm 130 defines the annex 160, and the second side 134 of the diaphragm defines the passage plenum 158.

The diaphragm 130 provides a gas valve 170. The diaphragm 130 is operably connected to a poppet 136 seated in the storage vessel port 150 in the base 162 which may be opposed to the diaphragm 130. The vessel port 150 comprises an orifice in the base 162 defining a frustocone. The poppet 136 is configured with a conical foot below a rod that is fastened to the second side 134 of the diaphragm 130.

The diaphragm 130 and the vessel port 150 provide the gas valve 170 that allows or blocks gas from passing from the interior volume 128 of the storage vessel 128 to the central segment 120 in the passage 140. Normally, the poppet 136 is seated in the vessel port 150 in a closed position to prevent passage of gas through the storage vessel port 150 in either direction. Hence, there are two valves shut against accidental discharge of gas from the storage vessel 100 through the passage 140: the gas valve 140 and the shut off valve 122. When a predetermined pressure is applied to the first side or the exterior side 132 of the diaphragm, the diaphragm flexes toward the base 162 and the poppet 136. The flexing diaphragm 130 moves the conical foot of the poppet away from the frustoconical seat in the storage vessel port 150 in the base 162 to an open position to allow gas through the vessel port 150 and hence through the passage 140 in either direction: toward the single nozzle 124 during discharge of gas from the storage vessel 100 or toward the interior volume 128 during charging of gas to the storage vessel.

The regulator 142 may be a step-down pressure regulator capable of dropping delivery pressure from a pressure greater than atmospheric to sub-atmospheric pressure depending on the pressure applied to the annex 154 on the exterior side 132 of the diaphragm 130. A pressure regulator line 116 is used to apply pressure to the exterior side 132 of the diaphragm 130. A first end of the pressure regulator line 116 communicates with the annex 160 in the chamber 154 through the pressure port 152. A second end 119 of the pressure regulator line 116 may communicate with a regulator pressure inlet 118. The regulator pressure inlet 118 may communicate the second end 119 of the pressure regulator line 116 with atmosphere or be hooked up to a pneumatic conduit to pressurize the annex 160.

The regulator 142 operates to provide gas from the storage vessel 100 at a steady pressure. When the pressure in the central segment 120 at the first end 141 of the passage 140 is higher than a set point, the diaphragm 130 flexes to a position that moves the poppet 136 to reduce or cut off flow to the passage 140. If the pressure in the central segment 120 at the first end 141 of the passage 140 is lower than a set point, the diaphragm 130 flexes to a position that moves the poppet 136 to increase flow to the passage 140. The set point is determined by the pressure in the annex 160 from the pressure regulator line 116 and the spring force necessary to move the diaphragm 130.

The chamber 154 has an outer wall 180 with a key 182 that mates with a keyhole 184 in the cavity 156 of the valve assembly 114 to properly orient the chamber 154 of the regulator 142 in the valve assembly 114. A plurality of paired keys 182 and keyholes 184 in the cavity 156 may be located at a plurality of locations on the outer wall 180. A filter 184 may be located between the interior volume 128 and the gas valve 170 at the second end 143 of the passage 140 to block passage of particulates which could damage equipment. A hollow cylindrical retainer 186 with external threading may be screwed into internal threading of the threaded plug 112 to hold the regulator 142 in place.

In an aspect, the second end 119 of the pressure regulator line 116 may communicate with a septum 172 in the regulator pressure inlet 118. The septum 172 isolates the pressure regulator line 116 and the annex 160 from the atmosphere. A needle 174 may be used to penetrate the septum 172 to allow gas from atmosphere or from a pressurized source to enter the pressure regulator line 116 and apply pressure to the first side or exterior side 132 of the diaphragm 130 to open the gas valve 170. The needle may be fixed on the end of a bolt 176 opposed to the septum 172. External threads of the bolt 176 may mate with internal threads of the inlet 118 to permit the needle to penetrate the septum in response to turning the bolt. A spacer 178 is shown in FIG. 1 which may be utilized to prevent the bolt 176 from turning and penetrating the septum 172 before applying pressure to the annex 160 is desired, such as during shipping before use of the gas in the storage vessel 100. The septum 172 may be made from a silicone rubber, for example, that can reseal after penetration.

The gas that is fed to the annex 160 of the pressure regulator 142 to control the pressure on the exterior side 132 of the diaphragm 130 does not come into contact with the gas stored in the storage vessel 100. The diaphragm 130 is an made of an impermeable material such as steel and edges of the diaphragm are bonded, preferably welded, to the outer wall 180 of the chamber 154 to prevent gas migration around the diaphragm.

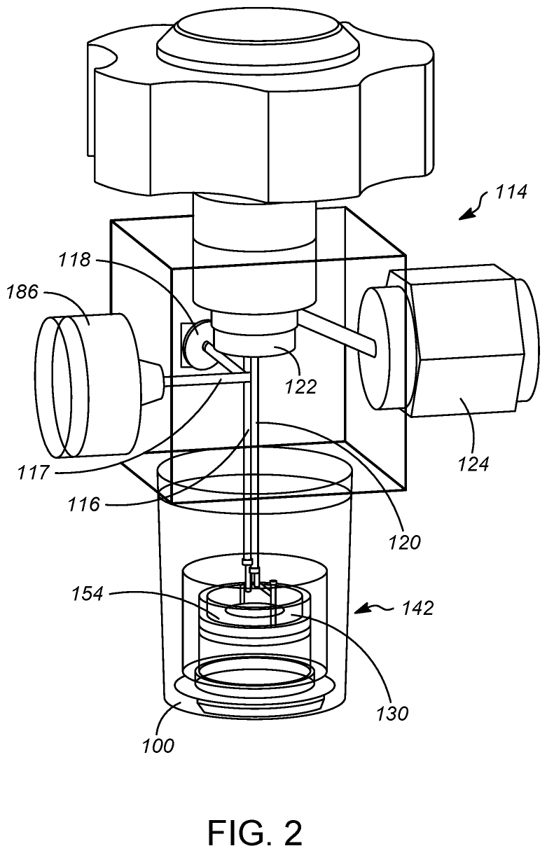

FIG. 2 shows another view of an alternative embodiment of FIG. 1 particularly showing the valve assembly 114 in which the regulator pressure inlet 118 is adjacent to the single nozzle 124. A mechanical pressure gauge 186 is in communication with the annex 154 of the pressure regulator 142 perhaps through a branch 117 off the pressure regulator line 116 that communicates therewith.

The pressure gauge 186 may provide an additional safety feature. Before the regulator pressure inlet 118 is opened, the gauge would be checked to see if the pressure is higher than expected which would indicate the diaphragm 130 may be ruptured. The pressure gauge 186 should measure pressure in a low-pressure range. The pressure gauge 186 may have use at the end user in which case the end user would only need to measure in the sub-atmospheric range. If the diaphragm 130 in the regulator 142 fails, the high-pressure gas will extend through the central passage 120 from the storage vessel 100 to the shut off valve 122. If the user does not know the diaphragm 130 has ruptured, the downstream system could be exposed to the high-pressure gas when hooked up to the valve assembly 114. The pressure gauge 186 instead will safely reveal that the diaphragm 130 has ruptured by inspection of the gauge before hook up to the downstream system.

Turning back to FIG. 1, the valve assembly may be used to dispense gas from the storage vessel in a process as follows. The single nozzle 124 may be hooked up to a downstream system. At the outset, the pressure in the annex 160 on the exterior or first side 132 of the diaphragm 130 may be at vacuum in which case the gas valve 170 blocks flow of gas because the poppet 136 is seated in the gas storage port 150. The pressure gauge 186 of FIG. 2 may be consulted to ensure the pressure in the pressure regulator line 116 is not higher than expected which would indicate a regulator failure. If the pressure is as expected, pressurized gas such as at atmospheric pressure may be allowed in through the regulator pressure inlet 118 to apply pressure to an exterior side or first side 132 of the diaphragm 130. In an aspect, opening the regulator pressure inlet 118 allows gas from the pressure regulator line 116 to enter the chamber 154 which contains the diaphragm 130. In an aspect, opening the pressure regulator inlet 118 may comprise urging the needle 174 to penetrate the septum 172 to permit gas to enter the pressure regulator line 116. The spacer 178 may be removed to allow the needle 174 to penetrate the septum 172. The gas valve 170 in the passage 140 may be opened by the diaphragm 130 flexing in response to pressure applied against the first or exterior side 132 to move the poppet 136 out of the vessel port 150 in the base 160. Movement of the poppet 136 allows gas to flow from the interior 128 of the storage vessel 100 from the second end 143 of the passage 140 past the vessel port 150 into a passage plenum 148 between the base 162 and the diaphragm 130. The passage plenum 158 is on the interior or second side 134 of the diaphragm 130. The passage plenum 158 is isolated from the annex 160 on the first or exterior side 132 of the diaphragm 130. Gas from the passage plenum 158 travels through the nozzle port 148 through the central passage 120, the shut off valve 122, and the nozzle passage 146 to the first end 141 of the passage 140 and through the single nozzle 124 to be dispensed to the downstream system.

When gas in the storage vessel 100 is fully discharged, the vessel can be recharged by disconnecting the downstream system from the single nozzle 124 and connecting a gas supply line to the single nozzle 124. The shut off valve 122 may be opened to communicate the passage 140 with the nozzle 124. The pressure regulator inlet line 116 is opened perhaps by opening the pressure regulator inlet 118 to apply pressure to the exterior side or the first side 132 of the diaphragm 130 which flexes to open the gas valve 170 in the passage 140. Recharge gas is allowed to pass from the gas supply line through the single nozzle 124 through the first end 141 of the passage 140, through the nozzle passage 146, past the shut off valve 122, the central passage 120, the nozzle port 148, the passage plenum 158, and past the gas valve 170 into the storage vessel 100.

A valve assembly 114 is provided that permits dispensing gas from and charging gas to the storage vessel 100 through the same nozzle 124 and passage 140. The valve is safer because only one passage 140 has access to the interior volume 128 of the storage vessel 100. Moreover, two valves, the gas valve 170 and the shut off valve 122 on the passage 140 prevent accidental discharge of gas.

While the following is described in conjunction with specific embodiments, it will be understood that this description is intended to illustrate and not limit the scope of the preceding description and the appended claims.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A valve assembly for dispensing gas from a storage vessel, comprising:
a single nozzle for communicating gas with the storage vessel;
a passage having a first end in communication with said single nozzle and a second end in communication with an interior volume of the storage vessel; and
a regulator interposed in said passage for regulating the flow of gas through said passage, said regulator having a vessel port, a nozzle port and a pressure port.

2. The valve assembly of claim 1 further comprising a shut off valve interposed in said passage for blocking or allowing gas to pass between said first end and said second end of said passage.

3. The valve assembly of claim 1 wherein said regulator includes a diaphragm operably connected to a poppet seated in said vessel port in a base opposed to said diaphragm such that when a predetermined pressure is applied to the diaphragm, the diaphragm flexes and moves the poppet to an open position to allow gas through said vessel port and said passage.

4. The valve assembly of claim 1 wherein said regulator comprises a chamber divided by said diaphragm into a passage plenum between said diaphragm and said base and an annex outside of said passage plenum; and said passage passing through said passage plenum.

5. The valve assembly of claim 4 wherein a first end of a pressure regulator line communicates with said annex.

6. The valve assembly of claim 5 further including a pressure gauge in communication with said annex.

7. The valve assembly of claim 5 wherein a second end of said pressure regulator line communicates with a septum that isolates the pressure regulator line from the atmosphere.

8. The valve assembly of claim 4 wherein said chamber has an outer wall with a key that mates with a keyhole in a cavity of said valve assembly to properly orient said chamber in said valve assembly.

9. The valve assembly of claim 1 coupled with the storage vessel.

10. A process for dispensing gas from a storage vessel comprising:
opening a shut off valve to communicate a passage with a nozzle;
applying pressure to an exterior side of a diaphragm which flexes to open a gas valve in said passage;
passing gas from the storage vessel through said passage past said gas valve and past said shut off valve to the nozzle.

11. The process of claim 10 further comprising opening a pressure regulator inlet and allowing gas from said pressure regulator line to enter a chamber which contains said diaphragm.

12. The process of claim 11 wherein opening said pressure regulator inlet comprises removing a spacer and urging a needle to penetrate a septum to permit gas to enter said pressure regulator line.

13. The process of claim 11 wherein opening said gas valve in said passage comprises said diaphragm moving a poppet out of a vessel port in a base and allowing gas to flow past said vessel port into a passage plenum between said base and said diaphragm.

14. The process of claim 12 wherein said pressure regulator line is in communication with an annex on said exterior side of said diaphragm and said passage plenum is on an interior side of said diaphragm and further comprising isolating said passage plenum from said annex.

15. The process of claim 11 further comprising:
connecting a gas supply line to the nozzle;
opening said shut off valve to communicate said passage with said nozzle;
opening said pressure regulator line to apply pressure to said exterior side of a diaphragm which flexes to open said gas valve in said passage;
passing gas from the gas supply line through said passage past said shut off valve and past said gas valve into the storage vessel.

16. A process for dispensing gas from a storage vessel comprising:
opening a shut off valve to communicate a passage with a nozzle;
applying pressure to a first side of a diaphragm which flexes to open a gas valve in said passage;
passing gas from the storage vessel, past said gas valve, through said passage defined by a second side of said diaphragm and past said shut off valve to the nozzle.

17. The process of claim 16 further comprising opening a pressure regulator inlet and allowing gas from said pressure regulator line to enter a chamber which contains said diaphragm.

18. The process of claim 17 wherein opening said gas valve in said passage comprises said diaphragm moving a poppet out of a vessel port in a base and allowing gas to flow past said vessel port into a passage plenum between said base and said diaphragm.

19. The process of claim 17 wherein said pressure regulator line is in communication with an annex on said first side of said diaphragm and said passage plenum is on a second side of said diaphragm and further comprising isolating said passage plenum from said annex.

20. The process of claim 15 further comprising:
connecting a gas supply line to the nozzle;
communicating said passage with said nozzle;
applying pressure to said first side of said diaphragm to open said gas valve in said passage;
passing gas from the gas supply line through said single nozzle past said gas valve into the storage vessel.
